(19) United States
(12) Patent Application Publication
(10) Pub. No.: US 2010/0314040 A1
(43) Pub. Date: Dec. 16, 2010

(54) FABRICATION OF METAMATERIALS

(75) Inventors: Talmage Tyler, II, Holly Springs, NC (US); Nan Marie Jokerst, Hillsborough, NC (US); David R. Smith, Durham, NC (US); Vinh N. Nguyen, Durham, NC (US); Jungsang Kim, Chapel Hill, NC (US); Serdar H. Yonak, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignees: Toyota Motor Engineering & Manufacturing North America, Inc., Erlanger, KY (US); Duke University, Durham, NC (US)

(21) Appl. No.: 12/481,785

(22) Filed: Jun. 10, 2009

(51) Int. Cl. B05D 5/12; B32B 38/14

(52) U.S. Cl. 156/278; 427/79

(57) ABSTRACT

An example method of fabricating a metamaterial comprises providing a first metamaterial layer, the first metamaterial layer including a first plurality of conducting patterns, such as electrically coupled resonators. A second metamaterial layer is then formed, including a second plurality of conducting patterns, to form a multilayer metamaterial. Positional alignment of the first and second plurality of conducting patterns can be achieved relative to the same fiducial mark, which may be associated with the first metamaterial layer, for example supported by a first substrate or on an alignment layer that is attached to the first substrate.

### FIELD OF THE INVENTION

The present invention relates to metamaterials, for example the fabrication of multilayer metamaterials.

### BACKGROUND OF THE INVENTION

Metamaterials are useful for a variety of applications. However, fabrication difficulties may increase cost or degrade performance. Improved methods of fabricating metamaterials would be extremely useful.

### SUMMARY OF THE INVENTION

Examples of the present invention include methods of fabricating a metamaterial having a multilayer assembly, allowing improved positional registration between structures on different layers without the need for complex alignment approaches. The structures may be conducting patterns, for example resonator patterns used in metamaterials. However, the conducting patterns need not be resonators.

A metamaterial may comprise a number of metamaterial layers, each metamaterial layer including a substrate supporting a plurality of structures, such as conducting patterns, such as resonant conducting patterns (resonators) or non-resonant conducting patterns. Conducting patterns may be formed by patterning or forming a conducting film, such as a metal film, supported by a surface of a substrate. The relative lateral positional arrangement of conducting patterns within any given metamaterial layer can be precisely controlled, for example using conventional lithography. However, there can be problems achieving lateral positional registration between conducting patterns on different layers of a multilayer assembly. In this example, a lateral direction is generally parallel to a surface, such as a substrate surface. Examples of the present invention allow such problems to be reduced or eliminated.

An example method of fabricating a metamaterial comprises providing a first metamaterial layer, including a substrate supporting a first arrangement of conducting patterns. The substrate may comprise one or more dielectric layers, such as one or more dielectric sheets, and may have a multilayer structure. For example, a substrate may comprise a dielectric sheet supporting one or more other dielectric layers, for example as surface coatings on a dielectric sheet. For example, the conducting patterns may be formed directly on a dielectric sheet, or optionally there may be additional intervening layers between the dielectric sheet and the conducting patterns. Additional intervening layers may be patterned, for example to assist formation of the conducting patterns.

A metamaterial may further include one or more spacer layers, for example to increase the spacing between pluralities of conducting patterns.

In some examples, the first metamaterial layer includes a fiducial mark of known spatial relationship (e.g. a known lateral spatial relationship) to the conducting patterns of the first metamaterial layer. For example, the fiducial mark may be supported by the first substrate, for example on an opposite side from the conducting patterns, or by another layer (an alignment layer) mechanically associated with the first substrate, for example an alignment layer rigidly attached to the substrate.

A second metamaterial layer can be formed on the first metamaterial layer, for example to form a stacked arrangement of metamaterial layers, using the same fiducial mark(s) associated with the first metamaterial layer for the lateral positional alignment of both first and second arrangements of conducting patterns.

For example, a second substrate can be attached to the first substrate, either directly or through one or more intervening layers, such as spacer layers. Attachment may use any appropriate approach, for example using any chemical or physical attachment. For example, a bonding layer (for example comprising any appropriate adhesive, or in some examples no adhesive) may be used for attachment. However, in some examples, attachment does not use a bonding layer. In some examples, a second substrate, spacer layer, or other layer may be formed on the first substrate by any desired approach, for example by deposition of one or more dielectric materials.

For example, after attaching the second substrate to the first metamaterial layer, directly or through one or more intervening layers such as spacer layers, a second arrangement of conducting patterns is formed on the second substrate, using the fiducial mark on the first substrate to position the second arrangement of conducting patterns on the second substrate. In this way, precise positional registration (in particular lateral positional accuracy) can be obtained between the first and second arrangement of conducting patterns, using the same fiducial mark for lateral positional registration of both arrangements (also termed pluralities) of conducting patterns.

The formation of conducting patterns on a second substrate allows a second metamaterial layer to be formed, which may be similar to the first metamaterial layer, or different. This approach can then be repeated according to the number of metamaterial layers required. For example, a third substrate can be attached to the second metamaterial layer, and a third arrangement of conducting patterns formed on the third substrate. The positional registration of the third arrangement of substrates on the third substrate can also use the same fiducial mark used to pattern other conducting patterns within the metamaterial, for example using a fiducial mark associated with the first substrate, for example located on the first substrate (e.g. on the opposite side from the conducting patterns), or on an alignment layer attached to the first substrate. Hence, precise positional registration between the first, second, and third arrangement of conducting patterns can be achieved, without any significant cumulative error being introduced as additional metamaterial layers are formed.

Conventional approaches may lead to cumulative errors in positional registration as additional metamaterial layers are formed. However, by using the same fiducial mark (e.g. on the first layer or an alignment layer bonded to the first layer) for conducting pattern positioning of the second and subsequent metamaterial layers, these cumulative errors can be avoided.

Positional registration using a fiducial mark allows improved positional registration between conducting patterns of different metamaterial layers to be achieved. Conducting patterns may be arranged in improved registration over a plurality of metamaterial layers. However, in some examples, conducting patterns may be laterally offset from one metamaterial layer to another. Examples of the present invention help reduce cumulative errors in any desired lateral offset (if any), allowing improved electromagnetic modeling, improved consistency of manufactured parameters, and other advantages to be achieved. Examples of the present invention allow improved matamaterial modeling to be achieved, with improved registration between actual conducting pattern locations and intended (or modeled) locations.

Metamaterial properties may be changed by variations in the relative positioning of the conducting patterns within a multilayer assembly. Hence, the properties of metamaterial lenses or other apparatus formed using the metamaterial may show undesirable manufacturing variations, requiring expensive and troublesome quality control and rejection of manufactured parts. Examples of the present invention can be used to reduce manufacturing variations in metamaterial properties.

Metamaterials can be designed using electromagnetic modeling of the metamaterial properties. Modeling accuracy is improved by improved registration accuracy in metamaterial layers. Hence, examples of the present invention can help remove sources of error in electromagnetic modeling, improving design processes.

Forming conducting patterns on the second substrate may include depositing a metal film (or other conducting film) on the second substrate (before or after bonding), and patterning of the conducting film to form the conducting patterns. The patterning is in positional registration with the first metamaterial layer using the fiducial mark.

Hence, second, third, fourth (and other) pluralities of conducting patterns can be accurately positioned relative to same fiducial mark that is used for positional alignment of the first metamaterial layers.

A second substrate may be attached to the first substrate using a bonding layer. For example, a bonding layer may include a layer of any suitable adhesive. The spacing of the metamaterial layers can be controlled using additional spacing layers, which may be located between successive metamaterial layers and bonded to each adjacent metamaterial layer. In some example, attachment is through a bonding process, and a bonding layer may include any appropriate adhesive, and no mechanical engagement or physical modification of the layers is required.

The first substrate may include a dielectric sheet, and has a first side and a second side. A first plurality of conducting patterns may be supported on the first side of the substrate, and a fiducial mark may be located on the second side of the substrate, or on another layer mechanically associated with the first substrate, such as an alignment layer attached to the second side of the substrate.

For example, an alignment layer supporting the fiducial mark may be attached to the first substrate, which may be a direct attachment or through one or more intervening dielectric layers. The fiducial mark can remain visible as additional metamaterial layers are added. For example, a second substrate may be attached to the first substrate using a first bonding layer, spacer layer, and a second bonding layer, with the first bonding layer bonding the first substrate to the spacer layer, and the second bonding layer bonding the spacer layer to the second substrate. The second substrate may comprise a dielectric sheet, and may have an essentially single layer or multilayer structure.

After bonding the second substrate to the first metamaterial layer, the conducting patterns on the first substrate may be concealed. However, a fiducial mark can be located so as to be visible after bonding is completed. After bonding, the second substrate may have no conducting patterns, and may present a generally featureless exposed surface. Conducting patterns may then be formed on the exposed surface of the second substrate, for example by patterning a conducting film. The conducting film may have previously been applied, or may be applied after bonding.

A fiducial mark may be located on the first substrate, or on an alignment layer attached to or otherwise mechanically associated with the first substrate. For example, an alignment layer may be a dielectric layer, possibly similar to a spacer layer, bonded to the first substrate on the opposite side to the conducting patterns.

An arrangement of conducting patterns on a substrate may comprise a patterned conducting film, such as a patterned metal film. For example, an arrangement of electrically-coupled inductor-capacitor resonators (ELC resonators) may be formed by patterning a conducting sheet on a surface of the substrate. The patterning may use lithography, and a mask aligner can be used to position a lithographic mask, and hence the resonators, by reference to the fiducial mark.

A second, third, or other plurality of conducting patterns can be formed on the corresponding substrate by depositing a conducting film on the corresponding substrate, and patterning the conducting film to form the second plurality of conducting patterns.

A substrate may be a dielectric sheet. The substrate material may be selected to have a low dielectric loss over the operating frequency range of the metamaterial. For example, the substrate may comprise a liquid crystal polymer. The substrate thickness may be between 1 microns and 1 mm, for example between 10 microns and 500 microns. The first substrate and the second substrate may be generally planar and parallel to each other.

Examples of the present invention include apparatus fabricated according to a method of the present invention. For example, a fabricated apparatus may be a metamaterial lens, for example a gradient index metamaterial lens configured to operate at radar frequencies. For example, examples of the present invention include metamaterial lenses with an operating frequency within the range 10 GHz-300 GHz, more particularly within the range 60 GHz-100 GHz.

### BRIEF DESCRIPTION OF THE DRAWINGS

FIGS. 1A-1C illustrate a metamaterial including two metamaterial layers, each metamaterial layer including a substrate supporting an arrangement of conducting patterns, the two metamaterial layers being bonded together using two bonding layers and a spacing layer;

FIGS. 2A and 2B show formation of fiducial marks;

FIGS. 3A and 3B illustrate formation of resonators on the first substrate aligned using the fiducial marks;

FIGS. 4A and 4B show bonding of a spacer layer and a second substrate to the first metamaterial layer; and

FIGS. 5A and 5B show alignment and patterning of resonators on the second substrate using the fiducial marks on the first substrate.

### DETAILED DESCRIPTION OF THE INVENTION

Examples of the present invention include improved methods of manufacturing a multilayer assembly, such as a metamaterial. Example methods facilitate alignment of structures, such as metamaterial components, from layer to layer within a multilayer assembly. In some examples, one or more fiducial marks (which may also be termed process marks) are formed on a first layer, and the fiducial marks are used to align any subsequent layers relative to the first layer. Examples include methods for manufacturing multilayer metamaterials, such as metamaterials comprising a plurality of dielectric layers having conducting patterns such as resonators disposed thereon.

An example metamaterial is a composite material having an artificial structure that can be tailored to obtain desired electromagnetic properties. A metamaterial may comprise an arrangement of resonators, which may be formed as electrically conducting patterns on an electrically non-conducting (dielectric) substrate. A metamaterial may have a number of substrates in a multilayer assembly, and the electromagnetic response of the metamaterial depends on resonator configuration and arrangements on the substrate, including relative positions of resonators on the same and different substrates.

In examples below, methods of fabricating metamaterials comprising a plurality of resonators are described. However, the invention is not limited to the use of resonant metamaterials, and examples of the invention include non-resonant metamaterials and methods of their manufacture.

A metamaterial can be fabricated having a desired electromagnetic property at a particular operating frequency, by adjustment of parameters such as unit cell dimensions, shape and size of conducting patterns therein, and the like. However, properties are sensitive to relative positions of conducting patterns, such as resonators, on different substrates, so improved control of the positional alignment, in particular between layers, allows improvement in metamaterial design and operation.

Examples include fabrication of multilayer metamaterials. Fabricated metamaterials may be in the form of a uniform slab or a gradient index lens.

Improved micro-fabrication methods described herein allow alignment to be retained from layer to layer, without the need for special alignment tooling. In some example, relative positional alignment along a direction parallel to a substrate surface can be controlled within 10 microns, in some examples within 1 micron, and in some examples to within approximately 0.5 microns. In contrast, the use of mechanical alignment methods (such as posts passed through drilled holes) restricts alignment accuracy to >150 microns.

Conventionally, alignment requires special alignment tooling (such as pins or a frame) or mechanical structures such as a special jig. Example methods facilitate alignment of metamaterial components from layer to layer without the use of such additional jigs or tooling.

In an example method, the first layer of a metamaterial is created using any appropriate method, for example metal deposition on a substrate followed by etch patterning via lift-off, or other micro-fabrication technique. The first metamaterial layer may include conducting patterns formed using a patterned metal film on a dielectric substrate such as a liquid crystal polymer or other substrate. A second substrate is then attached to the first layer before the formation of conducting patterns on the second substrate. A bonded assembly, for example a laminated assembly of metamaterial layers, can be placed in a mask aligner, and a conducting film is then deposited on the second substrate and patterned. The patterned conducting film can be very precisely aligned to one or more fiducial marks on the first layer. This process can be repeated as necessary according to the number of layers required, the conducting patterns on additional substrates can also be registered relative to the same fiducial mark.

In some examples, a fiducial mark may be formed on an alignment layer, and conducting patterns may be formed on the first substrate with positional reference to the fiducial mark after bonding to the alignment layer. An alignment layer may be attached (e.g. bonded or otherwise attached) to the first substrate, for example bonded to the opposite side to that used to support a first plurality of conducting patterns.

Each subsequent arrangement of conducting patterns can be precisely aligned with respect to the first layer, or other alignment layer, such that there is no build up of alignment errors as a multilayer metamaterial is being made. In addition, alignment creep between un-laminated layers is eliminated since the lamination process, which essentially solidifies the assembly of metamaterial layers, is accomplished before the next aligned layer is patterned.

In some examples, substrate layers without conducting patterns (spacer layers) may be interposed between substrate layers used to support conducting patterns. Spacer layers need not be aligned with other layers. For example, a spacer layer may be bonded to a first substrate layer. A second substrate layer is then bonded to the spacer layer, and a conducting pattern is then formed on the second substrate layer.

A metamaterial comprising stacked resonators (ELCs) on LCP substrates was fabricated using a mask aligner. Examples of the present invention include the fabrication of metamaterials comprising resonant or non-resonant conducting patterns.

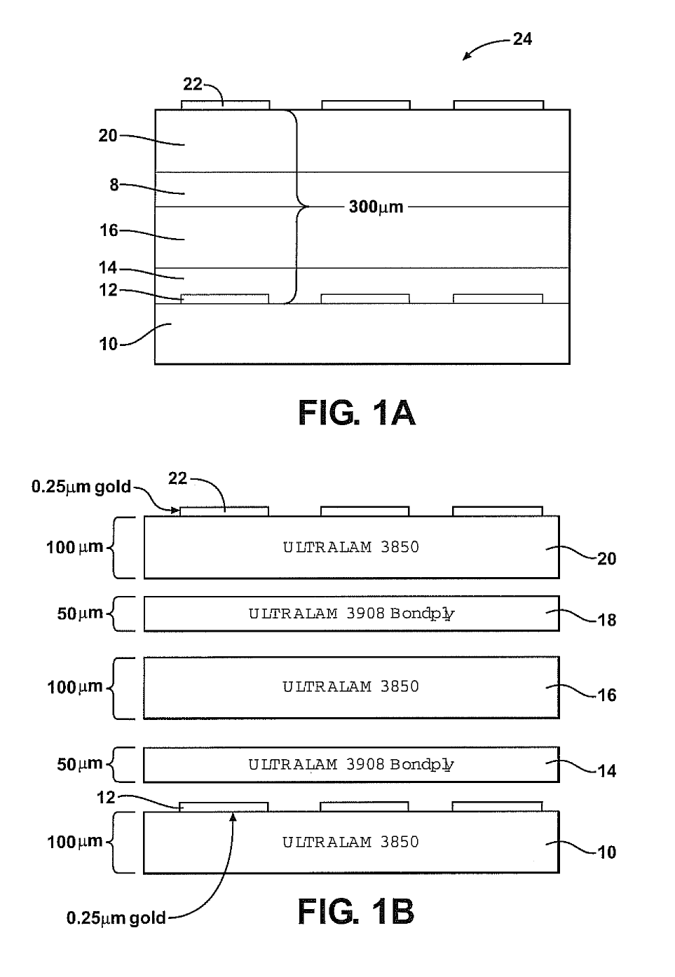

FIGS. 1A-1C illustrate a metamaterial including two metamaterial layers, each metamaterial layer including a substrate supporting an arrangement of resonators, the two metamaterial layers being bonded together using two bonding layers and a spacing layer.

FIG. 1A shows a portion of the fabricated metamaterial 24 in cross-section, showing first substrate 10, conducting patterns in the form of resonators supported by the first substrate (12), bonding layer 14, spacer layer 16, second bonding layer 18, second substrate 20, and resonators supported by the second substrate (22). In this example, first and second arrays of resonators are separated by 300 microns. Examples of the present invention allow facilitation and/or improvement of positional alignment between resonators 12 and 22.

FIG. 1B is similar to FIG. 1A, with substrates, bonding layers, and the spacer layer separated for illustrative clarity. In this example, the resonators are formed by patterned 0.25 micron thickness gold film on the substrate. The substrate layers and the spacer layer used comprised ULTRALAM 3850 (Rogers Corporation, Chandler, Ariz.), and bonding layers comprising ULTRALAM 3908 Bondply was used to bond the layers together.

FIG. 1C is a further view, showing the configuration of resonators on the first and second substrates. In this example, the resonators are electrically coupled inductor-capacitor resonators.

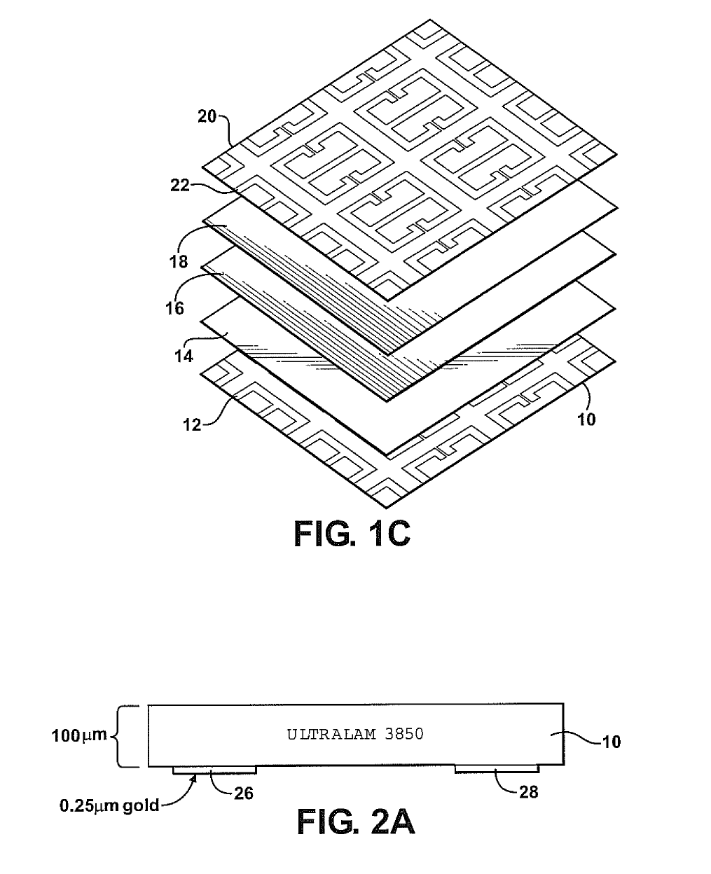

FIGS. 2A and 2B show formation of fiducial marks on the first substrate, including crosses 26 and 28 on the lower side (as illustrated) of the first substrate 10. FIG. 2A is a cross-sectional view, and FIG. 1B shows a lower view. In this example, the fiducial marks include two cross-patterned gold films. More specifically, the cross-patterns are formed using a 10 nm chromium film and 0.25 micron gold film in a metal stack.

There may be one or more fiducial marks on the first substrate. The fiducial marks can be configured to be detectable by the optical system of conventional mask aligners, or other mask alignment systems.

In other examples, a fiducial mark is formed on an alignment layer associated with the first substrate. The alignment layer may be rigidly attached, for example bonded, to the first substrate.

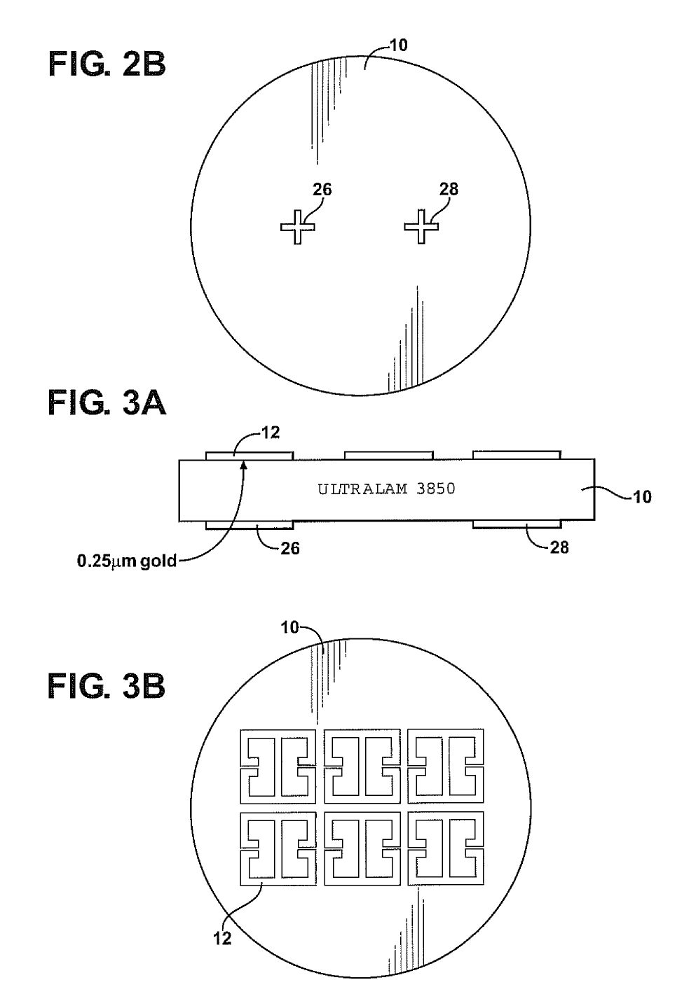

FIGS. 3A and 3B illustrate formation of resonators (such as resonator 12) on the first substrate. The resonators on the first substrate are positionally aligned using the fiducial marks, there being known spatial relationships between the fiducial marks and the resonator positions. In this context, position alignment may correspond to positioning of a resonator pattern, for example as defined by a lithographic mask, on the substrate. Alignment may include lateral positioning in a direction parallel to the substrate surface.

The figures are simplified for illustrative clarity, as the substrate would generally include many more resonators than shown.

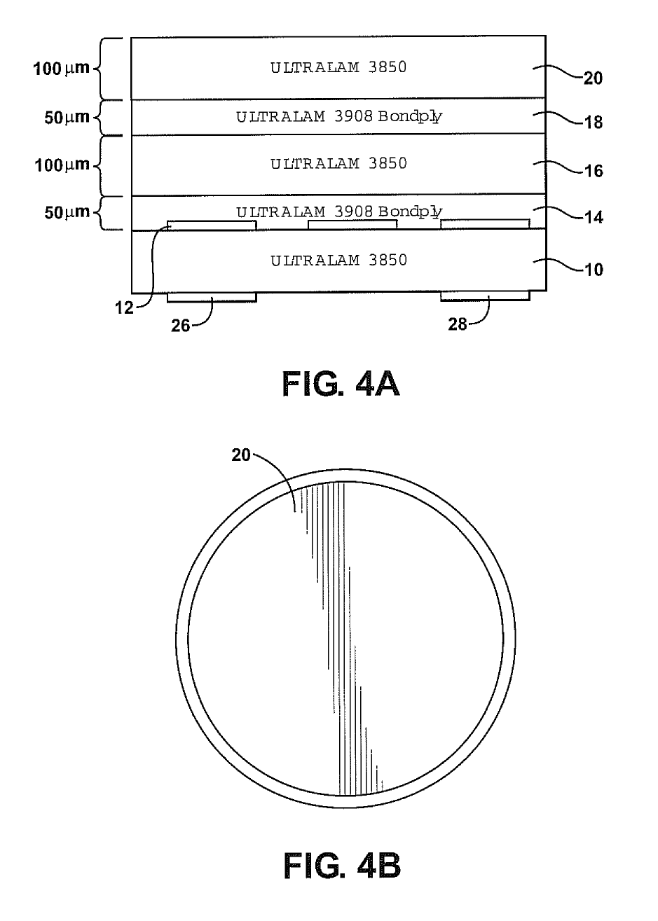

FIGS. 4A and 4B show attachment of a spacer layer and a second substrate to the first metamaterial layer. In this example, the second substrate is bonded to the first substrate using bonding layers and a spacer layer. The attachment process may include one or more bonding layers. Preferably, the second substrate is then rigidly attached to the first substrate before forming the resonators on the exposed surface of the second substrate.

FIG. 4A shows assembly of the first bonding layer, spacer layer, second bonding layer, and second substrate on the first metamaterial layer. FIG. 4B shows the exposed surface of the second substrate 20 after assembly. As illustrated, this shows a top view of the second substrate. In this example, there is no patterned conducting film on the second substrate until after bonding is complete.

In some examples, an unpatterned conducting film may be formed on the second substrate before bonding, with patterning occurring after bonding. In that case, FIG. 4B would show the unpatterned metal film.

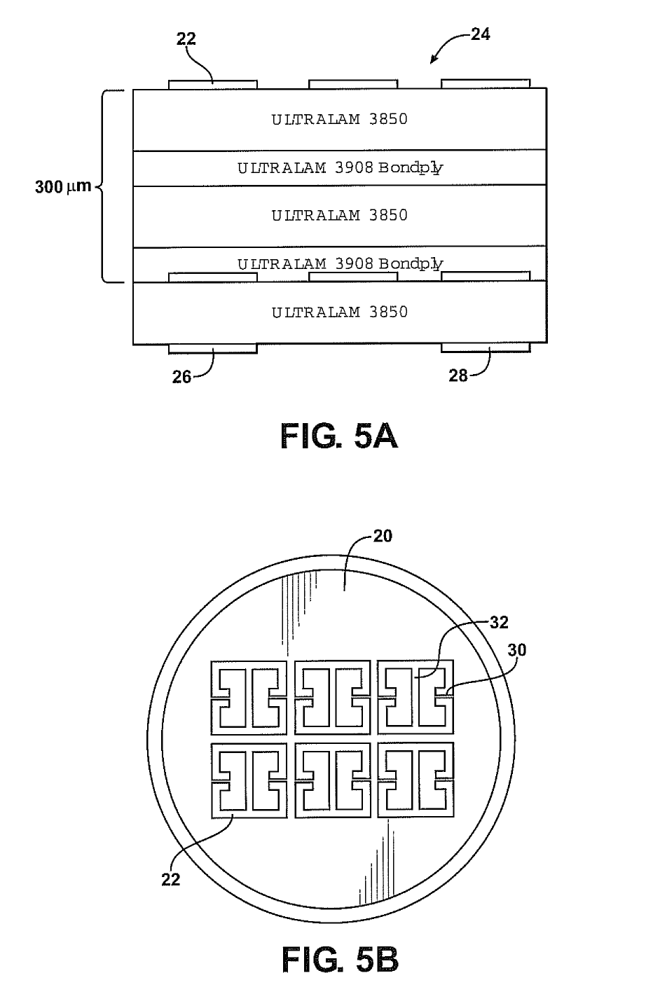

FIGS. 5A and 5B show alignment and patterning of resonators on the second substrate using the fiducial marks on the first substrate.

FIG. 5A shows a patterned conducting metal film, giving the resonators such as 20. FIG. 5B shows a top view. This is a simplified figure, as there would be typically many more resonators formed. The resonators on the second substrate are aligned with respect to the fiducial marks 26 and 28.

In this example, the resonators are ELC resonators, and in a fabricated example were comprise metal tracks in a generally square form with a side length of approximately 400 microns. The resonators have a central arm 32, and a pair of outer arms each having a capacitive gap 30. The self-inductance of the metal tracks and the capacitance of the capacitive gaps give resonant properties. The operational frequency of a metamaterial may be close to resonance (particularly for negative index material applications, such as cloaking devices), or in other applications may be away from resonance (for example, for low-loss applications).

A fiducial mark may be used to align conducting pattern positions across multiple layers of a multilayer metamaterial. In some examples, a fiducial mark is located on the first substrate, and can be used for alignment of conducting patterns patterned in the first substrate. In some examples, an alignment layer is attached to the first substrate, and a fiducial mark is located alignment substrate.

In examples of the present invention, the same fiducial mark can be used to align conducting pattern positions on a plurality of substrates within a multilayer assembly. A plurality of substrates may be bonded together, and conducting patterns on each substrate can formed after bonding of that substrate, and positionally aligned using the same fiducial mark used for the other substrates.

A fiducial mark may comprise patterned metal films, and in some examples may be formed using similar metal films to those used to pattern the conducting patterns. A fiducial mark may comprise a cross, line, circle, other geometric pattern, resonator pattern, other conducting pattern, and the like. However, any type of fiducial mark may be used. The composition, shape, or number of such marks may be selected according to the process used to fabricate the metamaterial, for example as required by a mask aligner. For example, a fiducial mark may comprise grooves, dyes, or other marks.

A fiducial mark may occupy several square millimeters a substrate or alignment layer. A fiducial mark may optionally be removed after fabrication of the metamaterial, for example if the fiducial mark would appreciably interfere with metamaterial device operation.

In some examples, a fiducial mark is selected so as to be detectable by a mask aligner. A mask aligner detects the fiducial mark, and positions a lithographic mask so as to allow fabrication of a conducting pattern array (such as a resonator array) with the desired positional registration on the substrate. One or more fiducial marks may be used, for example on the first substrate or an alignment layer attached thereto.

A metamaterial under fabrication may be passed between a mask aligner and a bonding press (or other equipment used to bond additional layers to those existing layers, such as a laminator). The bonding press can be used to bond a new substrate to an existing metamaterial assembly. The mask aligner is then used to pattern the newly bonded substrate with conducting patterns. The mask aligner uses the same fiducial mark for mask alignment of each additional layer.

Applications of the present invention include improved lithographic patterning of conducting patterns within a multilayer metamaterial. However, the invention is not limited to any particular fabrication approach, and can be used with other methods of conducting pattern fabrication on a substrate, such as patterned deposition of conducting films, self-assembly of particles (such as metallic nanoparticles), laser etching, other physical or chemical patterning methods, and the like.

Metamaterials according to examples of the present invention may be used in lenses, such as a gradient index lens for millimeter-wave radiations. A metamaterial lens may include a plurality of substrates, each substrate supporting an array of conducting patterns, such as resonators. Each array of conducting patterns may be aligned to a fiducial mark on one of the substrates. For gradient index lenses, one or more conducting pattern arrays may have a parameter, such as resonance frequency, that varies as a function of position over the substrate(s). For example, the capacitor value of a capacitive gap may vary with spatial position on a substrate, for example by varying the capacitive gap geometry.

Examples of the present invention further include microwave devices, in particular millimeter wave devices for radar applications (such as automotive radar applications), imaging applications, or other microwave and/or millimeter wave applications. Examples of the present invention include metamaterials (e.g. artificial dielectric materials) for use in any microwave or millimeter-wave application, for example an absorber, reflector, beam steering device, and the like, and improved methods of fabricating any such device. Examples of the present invention include improved methods of fabrication of any apparatus described herein, such as a radar device, a metamaterial lens, or any other metamaterial device.

Examples of the present invention include devices configured to function at radar frequencies, for example automotive radar frequencies of approximately 77 GHz. Example applications include elements for improved 77 gigahertz and 77-81 gigahertz automotive radars, 94 GHz mm-wave imaging apparatus, and applications at 120 GHz, 220 GHz, or other frequencies. Example applications include sources and receivers, imaging devices, and other radar apparatus. Metamaterials may be flexible, and may be conformed to an underlying support structure.

Conducting patterns used to form conducting patterns, bias lines, and the like may comprise electrically conducting films, for example metal films formed on a generally planar substrate. The substrate surface may include regions of semiconductor deposited on a support layer. Conducting segments may be etched or otherwise patterned from a conducting film. Conducting patterns may comprise a metal, such as a noble metal (for example, Pt or Au), other platinum group metal, other transition metal, other metal such as Al. Conducting patterns may comprise conducting alloys (such as alloys of the metals mentioned above), conducting polymers, and the like.

Conducting patterns, such as resonators, on a substrate may be arranged in an array with a generally repeating pattern having a unit cell. The unit cell dimension may be in the range 10 microns-1 mm, e.g. 100 microns-1 mm, for example approximately 300-600 microns on a square side. An example conducting pattern, such as a resonator, may have a generally square shape with a side length less than the unit cell dimensions. Bias lines may also be provided, in the case of electrically tunable metamaterials. However, the invention is not limited to any particular form of resonator. An example resonator or other conducting pattern may be generally ring shaped, square shaped, or otherwise configured. In some examples, conducting patterns may be formed by patterning a conducting sheet, such as a metal film.

A capacitive gap thickness of capacitor(s) within an ELC resonator may be in the range 0.5 microns-100 microns, for example in the range 1-20 microns, more particularly in the range 1-10 microns. The conducting film thickness (e.g. metal film thickness) of a conducting pattern may be in the range 0.1-10 microns. The conducting film may be a metal, such as gold, silver, platinum, aluminum, or other metal, and an adhesion promoter such as Cr may also be used. A conducting film may comprise a conducting polymer. All ranges are inclusive.

Conducting patterns may be formed by patterning of a conducting film (in this context, a conducting film refers to an electrically conducting film), for example using any lithography method. In some examples, a conducting film may be patterned by chemical etching. In some examples, a conducting film may be patterned by physical patterning, such as a laser ablation, mechanical removal of conducting material (e.g. scratching, scribing, abrasion, and the like). In some examples, conducting patterns may be formed directly, for example by depositing a patterned arrangement of conducting material on a substrate. Approaches may include self-assembly of conducting elements (such as nanoparticles).

For example, a chemically and/or physically patterned layer may be deposited on a dielectric sheet, the patterned layer then being used to spatially direct deposition and/or formation of conducting material. In other examples, a deposited layer, initially non-conducting, may be spatially selectively converted to a conducting material. Alternatively, a deposited non-conducting layer may be spatially selectively converted to a non-conducting material. Example approaches include spatially-selective techniques such as isomerization (e.g. photoisomerization), ion implantation, other doping, or other chemical or physical process.

Substrates may include one or more layers, such as one or more dielectric sheets, and are preferably low loss at the frequency range of operation. Substrates may include a generally planar dielectric sheet, and may be rigid or flexible. Spacer layers may have similar composition to substrates used to support conducting pattern arrangements. A substrate can be used to support a plurality of conducting patterns.

A dielectric substrate may include a dielectric sheet, for example a dielectric sheet including a liquid crystal polymer (LCP). For example, a dielectric sheet may be selected from the Rogers ULTRALAM™ 3000 series (Rogers Corporation, Chandler, Ariz.), for example as used for printed wiring boards (PWB). Example metamaterials may comprise, for example, 1-50 layers, for example 5-20 metamaterial layers, but the number of conducting pattern arrays, substrates, and/or dielectric sheets is not limited by these examples, and may be any number to obtain desired properties.

A substrate (and/or spacer layer) may comprise a polymer (such as a liquid crystal polymer), semiconductor (such as silicon, GaAs, other arsenide semiconductor, other III-V semiconductor, a chalcogenide or other II-VI semiconductor, and the like), glass (such as borosilicate glass, such as Pyrex™, in particular Pyrex 7740 borosilicate glass, Corning, Inc., Corning, N.Y.), ceramic or glass-ceramic material, other electrically insulating or semiconductor material, and the like.

For example, a substrate may comprise one or more of the following: an organic material, such as an organic resin; a polymer such as a liquid crystal polymer (LCP); other polymeric material. A substrate may comprise a sheet comprising a polymer, a composite, or other polymeric material; an inorganic material such as a ceramic, glass, composite, or other inorganic material; other material; or combination thereof.

In some examples, a substrate may include one or more semiconductor layers, for example a doped or intrinsic semiconductor layer. A substrate layer may comprise silicon, germanium, an arsenide, a nitride, an oxide, or other material.

For example, a substrate may comprise one or more of the following, possibly as one or more dielectric sheets: a fluoropolymer-ceramic substrate, e.g. a micro-dispersed ceramic-PTFE composite such as CLTE-XT from Arlon, Cucamonga, Calif.; a PTFE glass fiber material such as Rogers RT/Duroid 5880/RO 3003; LTCC (Low Temperature Co-Fired Ceramic); a dielectric oxide such as alumina; a polyxylylene polymer such as parylene-N; a fluoropolymer, e.g. a polytetrafluoroethylene such as Teflon™ DuPont, Wilmington, Pa.), a liquid crystal polymer, or other low-loss material at the frequency or frequency range of interest. A low loss material may have a dielectric loss equal to or less than 0.1 at a metamaterial operating frequency, in some example 0.01, or 0.001, or less. A substrate may comprise one or more dielectric sheets or other layers, the composition of which may be the same or different.

Examples of the present invention allow precise positional registration between conducting patterns on different substrates within a multilayer metamaterial, in some examples with registration accuracy (e.g. lateral positioning accuracy) better than 10 microns, in particular better than 1 micron (i.e. submicron registration accuracy). Positioning accuracy may be substantially free of cumulative errors as additional metamaterial layers are added. Examples include conducting pattern arrangements where the conducting patterns are precisely stacked relative to each other over multiple layers, but are not limited to such examples. Any desired arrangement of conducting patterns is possible, with improved positional accuracy of conducting patterns compared to the desired locations being obtained.

A multilayer metamaterial may comprise a plurality of conducting pattern arrangements, each conducting pattern arrangement spaced apart by a metamaterial dielectric spacing assembly. A metamaterial dielectric spacing assembly may comprise a substrate used to support a conducting pattern arrangement, one or more spacer layers, optional bonding layers, other layers as needed, and the like. A substrate or spacer layer may itself have a multilayer structure. For example, a substrate may comprise a dielectric sheet used to support the conducting patterns. However, there may be one or more intervening layers between the dielectric sheet and the conducting patterns. The intervening layers may be continuous or patterned. For example, an intervening layer may be used for one or more of the following purposes: modification of the mean-field electromagnetic properties, adhesion promotion, facilitation of patterned deposition of conducting materials, and the like.

Attachment of a material, such as a spacer or a substrate, to another metamaterial component, such as another spacer or substrate, may comprise bonding (e.g. thermal or adhesion based bonding), physical attachment using one or more fasteners (such as screws, rods, snaps, clips, clamps, and the like), or other approach. A bonding layer may be used, though this is not necessary.

A layer material, such as a spacer or a substrate, may be attached to another metamaterial component, such as another spacer or substrate, directly or through one or more intervening components, such as other spacer layers. For example, attachment of a first substrate to a second substrate may be a direct attachment, or there may be one or more intervening spacer layers used.

Attachment of an additional substrate to an existing metamaterial structure may be a rigid attachment. In some examples, an attachment does not allow significant lateral motion between attached elements, particularly between substrates. In this context, significant lateral motion is that which compromises the lateral spatial accuracy of conducting pattern formation. A lateral direction may be generally parallel to the substrate surface, e.g. for a sheet-like substrate.

Examples of the present invention include methods of fabricating a multilayer assembly, allowing improved positional registration between structures on different layers without the need for complex alignment approaches, in some examples improved relative lateral positioning accuracy in a direction generally parallel to metamaterial substrate surfaces. The structures may be conducting patterns, for example conducting patterns used in metamaterials. The conducting patterns may be resonators, but examples of the present invention include non-resonant metamaterials. In some examples, the structures may be other components, such as electronic circuit component, pads for supporting electronic components, conducting films, tracks, other conducting patterns, and the like.

Examples of the present invention include fabrication of metamaterials comprising patterned metal films on a dielectric substrate. Other examples include fabrication of any metamaterial where patterning of multiple layers is used. A fiducial mark associated with a first metamaterial layer, or alignment layer attached to it, can be used for pattern alignment of any subsequent layers.

The invention is not restricted to the illustrative examples described above. Examples described are exemplary, and are not intended to limit the scope of the invention. Changes therein, other combinations of elements, and other uses will occur to those skilled in the art. The scope of the invention is defined by the scope of the claims.

Having described our invention, we claim:

1. A method of forming a multilayer metamaterial, the method comprising:
forming a first metamaterial layer, the first metamaterial layer including a first plurality of conducting patterns,
the first plurality of conducting patterns being positionally aligned using a fiducial mark supported by the first metamaterial layer; and
forming a second metamaterial layer, the second metamaterial layer including a second plurality of conducting patterns,
the second metamaterial layer being attached to the first metamaterial layer so as to form the multilayer metamaterial,
the second plurality of conducting patterns being positionally aligned using the fiducial mark supported by the first metamaterial layer.

2. The method of claim 1, further comprising:
forming a third metamaterial layer, the third metamaterial layer including a third plurality of conducting patterns,
the third plurality of conducting patterns being positionally aligned using the fiducial mark supported by the first metamaterial layer.

3. The method of claim 1, the first metamaterial layer including a first substrate and a first plurality of conducting patterns supported by the first substrate,
the fiducial mark being located on the first substrate or on an alignment layer attached to the first substrate.

4. The method of claim 3, wherein forming the first metamaterial layer includes:
providing a fiducial mark on the first substrate on the first substrate or on an alignment layer attached to the first substrate; and
forming the first plurality of conducting patterns on the first substrate,
the first plurality of conducting patterns being laterally positionally aligned on the first substrate using the fiducial mark.

5. The method of claim 47 the first plurality of conducting patterns being formed by patterning a conducting film supported by the first substrate.

6. The method of claim 3, wherein forming the second metamaterial layer includes:
attaching a second substrate to the first metamaterial layer; and
forming the second plurality of conducting patterns on the second substrate,
the second plurality of conducting patterns being laterally positioned on the second substrate using the fiducial mark.

7. The method of claim 6, the second plurality of conducting patterns being formed on the second substrate after the second substrate is attached to the first metamaterial layer.

8. The method of claim 6, wherein attaching a second substrate to the first metamaterial layer comprises attaching the second substrate being to the first substrate using a bonding layer.

9. The method of claim 8, wherein attaching a second substrate to the first metamaterial layer comprises attaching the second substrate being to the first substrate using the bonding layer, a spacer layer, and a second bonding layer,
the bonding layer being located between the first substrate and the spacer layer,
the second bonding layer being located between the spacer layer and the second substrate.

10. The method of claim 1, the method including:
forming the first plurality of conducting patterns and the second plurality of conducting patterns using a mask aligner,
the mask aligner using the fiducial mark to positionally align both the first plurality of conducting patterns and the second plurality of conducting patterns.

11. The method of claim 1 wherein the conducting patterns are electrically coupled inductor-capacitor resonators (ELC resonators).

12. The method of claim 1, the metamaterial being a metamaterial lens, the method being a method of fabricating a metamaterial lens.

13. A method of fabricating a multilayer metamaterial, the method comprising:
forming a first metamaterial layer, the first metamaterial layer including a first substrate and a first plurality of resonators supported by the first substrate,
the first plurality of conducting patterns being positioned on the first substrate using a fiducial mark associated with the first metamaterial layer; and
forming a second metamaterial layer, the second metamaterial layer including a second substrate and a second plurality of resonators supported by the second substrate,
the second plurality of conducting patterns positioned on the second substrate using positional alignment relative to the fiducial mark associated with the first metamaterial layer,
the second metamaterial layer being attached to the first metamaterial layer so as to form the multilayer metamaterial.

14. The method of claim 13, the second substrate being attached to the first substrate before the second plurality of resonators is formed on the second substrate.

15. The method of claim 14, the second substrate being attached to the first substrate using a first bonding layer, a spacer layer, and a second bonding layer,
the first bonding layer being located between the first substrate and the spacer layer,
the second bonding layer being located between the spacer layer and the second substrate.

16. The method of claim 13, wherein forming a first metamaterial layer includes:
providing a fiducial mark on the first substrate or on an alignment layer attached to the first substrate; and
forming the resonators first substrate, the resonators being positionally aligned using the fiducial mark,
and wherein forming a second metamaterial layer includes:
attaching the second substrate to the first metamaterial layer;
forming a second plurality of resonators on the second substrate, after the second substrate is attached to the first metamaterial layer,
the second plurality of resonators being positioned on the second substrate using the fiducial mark.

17. The method of claim 13, forming the first plurality of resonators including patterning a first conducting film supported by the first substrate; and
forming the second plurality of resonators including patterning a second conducting film supported by the second substrate.

18. The method of claim 17, the first and second pluralities of resonators being formed using a mask aligner,
the mask aligner detecting the fiducial mark and using the fiducial mark to positionally align the first and second pluralities of resonators.

19. A method of forming a multilayer metamaterial, the method comprising forming a plurality of metamaterial layers, each metamaterial layer comprising a plurality of conducting patterns,
positional registration of each plurality of conducting patterns being achieved using a fiducial mark.

20. The method of claim 19, the method further comprising:
forming a first metamaterial layer, the first metamaterial layer including a first plurality of conducting patterns,
the first plurality of conducting patterns being positionally aligned using a fiducial mark supported by a dielectric layer of the first metamaterial layer; and
the positional alignment of remaining conducting patterns being determined using the fiducial mark.

21. The method of claim 19, the metamaterial comprising a plurality of generally parallel dielectric sheets,
positional alignment being lateral alignment within a parallel to surfaces of the generally parallel dielectric sheets.

22. The method of claim 227 wherein the dielectric sheets each comprises a liquid crystal polymer,
the metamaterial being configured to operate as a metamaterial lens at an operating frequency,
the operating frequency being within the range 10 GHz-300 GHz.

23. A method of fabricating a multilayer metamaterial, the method comprising:
forming a first metamaterial layer, including forming a first plurality conducting patterns on a first substrate, the first plurality of conducting patterns being positionally aligned using a fiducial mark associated with the first substrate; and
forming a second metamaterial layer, including forming a second plurality of conducting patterns on a second substrate,
the second plurality of conducting patterns being formed on the second substrate after the second substrate is bonded to the first substrate,
the second plurality of conducting patterns being positionally aligned on the second substrate using the fiducial mark associated with the first substrate.

24. The method of claim 23, the a second substrate being bonded to the first substrate using a first bonding layer, a spacer layer, and a second bonding layer,
the first bonding layer being located between the first substrate and the spacer layer,
the second bonding layer being located between the spacer layer and the second substrate,
the second plurality of conducting patterns being supported by the second substrate.

25. The method of claim 23, further comprising;
attaching a third substrate to the second substrate;
forming a third plurality of conducting patterns on the third substrate,
the third plurality of conducting patterns being positionally aligned on the third substrate using the fiducial mark,
the third plurality of conducting patterns being formed on the third substrate after the third substrate is attached to the second substrate.

26. The method of claim 25, wherein the third substrate is attached to the second substrate through a second spacer layer.
